(19) United States
(12) Patent Application Publication
(10) Pub. No.: US 2007/0171083 A1
(43) Pub. Date: Jul. 26, 2007

(54) Monitoring moisture inside a container

(76) Inventor: Yuen-Foo Michael Kou, Andover, MA (US)

Correspondence Address: FISH & RICHARDSON P.C., P.O BOX 1022, Minneapolis, MN, 55440-1022, US

(21) Appl. No.: 11/653,595

(22) Filed: Jan. 16, 2007

Related U.S. Application Data
(63) Continuation-in-part of application No. 11/061,589, filed on Feb. 18, 2005.

(51) Int. Cl. G08B 21/00

(52) U.S. Cl. 340/604

(57) ABSTRACT

A method of monitoring moisture inside a container includes placing a moisture sensitive product and an electronic moisture sensor inside the container, using the electronic moisture sensor to sense moisture conditions inside the container and, in response to a triggering event initiated from outside the container, transmitting data through the container. The transmitted data is relevant to an assessment of the moisture sensitive product's condition, based on the recorded data. Electronic moisture sensors and systems are also provided employing similar methods.

### CROSS REFERENCE TO RELATED APPLICATION(S)

This application is a continuation-in-part of and claims the benefit of priority from co-pending U.S. patent application Ser. No. 11/061,589, filed Feb. 18, 2005 and entitled “Data Transfer Between Moisture Sensors,” which is incorporated by reference.

### TECHNICAL FIELD

This invention relates to monitoring moisture inside a container and, more particularly, to monitoring moisture inside a container that is holding moisture-sensitive components.

### BACKGROUND

Moisture sensitive products include, for example, certain electronic components, pharmaceutical products, and certain machinery.

During transport, moisture sensitive products can be packaged inside containers that provide some degree of protection from exposure to ambient moisture. Moreover, desiccants, such as packaged silica gel, can be provided to further minimize the possibility of damage occurring from exposure to ambient moisture. Additionally, dry storage containers may be provided to store moisture sensitive products over extended periods of time.

Despite those precautionary measures, moisture sensitive products are sometimes exposed to potentially harmful amounts of moisture. Moisture damage can manifest itself in a variety of ways. For example, machinery can rust, electronic components can be made susceptible to being damaged by reflow soldering processes and pharmaceutical products can be comprised.

### SUMMARY OF THE INVENTION

Various aspects of the invention feature methods of monitoring moisture inside a container. In one implementation, a method of monitoring moisture inside a container includes placing an electronic moisture sensor inside the container. The container typically houses moisture sensitive products. The method further includes using the electronic moisture sensor to sense moisture conditions inside the container and, in response to a triggering event initiated from outside the container, transmitting data through the container. The transmitted data is relevant to an assessment of the moisture sensitive product's condition, based on the recorded data.

In another implementation, a container system includes a container adapted to provide a moisture barrier around a moisture sensitive product and an electronic moisture sensor inside the container. The electronic moisture sensor includes a moisture sensor adapted to sense ambient moisture conditions, a memory storage device coupled to the moisture sensor and adapted to store data from the moisture sensor, an internal transceiver module coupled to the memory storage device and adapted to transmit the stored data over a wireless communications channel, and a responsive element coupled to the transmission module and adapted to, in response to an applied field or signal, activate the transmission module to begin transmitting.

In yet another implementation, an electronic moisture sensor or recorder is provided including a moisture sensor or sensor element adapted to sense ambient moisture conditions. A memory storage device is coupled to the moisture sensor for storing data from the moisture sensor element. A transceiver module is coupled to the memory storage device and adapted to transmit the stored data over a wireless communications channel. A passive responsive element is coupled to the transmission module and adapted, in response to an applied field or signal, to activate the transmission module to begin transmitting. In one implementation the responsive element is a passive magnetically responsive element that responds to an applied magnetic field to activate the transmission.

In some implementations, one or more of the following advantages may be present. Data recorded by an electronic moisture sensor inside a moisture resistant container can be accessed and/or analyzed without needing to open the container. Therefore, the possibility of exposing moisture sensitive components to potentially harmful ambient moisture conditions outside the container is reduced. Such data can be accessed even if the container is opaque. Moreover, battery life in an electronic moisture sensor can be prolonged.

Other features and advantages will also be apparent from the following description and drawings.

### BRIEF DESCRIPTION OF THE DRAWINGS

FIG. 1 is a flowchart of a method of monitoring moisture inside a container.

FIG. 2 illustrates an electronic moisture sensor.

FIG. 3 is a block diagram of a system for monitoring moisture in a container.

FIG. 4 is a partial view of an electronic moisture sensor coupled to a moisture sensitive product inside a container.

Like reference numbers indicate like elements.

### DETAILED DESCRIPTION

FIG. 1 is a flowchart detailing a particular implementation of a method to monitor moisture content inside a container. The container is holding a moisture sensitive component and serves as a moisture barrier preventing the infiltration of ambient moisture into the container. The illustrated method is modifiable in ways that will be readily understood by those possessing ordinary skill in the art.

According to the illustrated implementation, a user creates 102 an association between a moisture sensitive product and an electronic moisture sensor. In some implementations, that association is created by placing the moisture sensitive product and the electronic moisture sensor together inside the container. In some implementations, the electronic moisture sensor is physically connected to the moisture sensitive product.

An example of that is shown in FIG. 4, where an electronic moisture sensor 200 is connected to a tray 404, upon which moisture sensitive electronic components 402 are positioned. In particular, the electronic moisture sensor 200 is slid or clipped to an edge feature 528 of the tray 404, such that it may eventually be removed from the tray 404 and reused. The moisture sensitive products 402 and the electronic moisture sensor 200 in FIG. 4 are positioned together inside a moisture resistant container 406. The illustrated container 406 includes a seal 408 that tends to resist the infiltration of moisture. In another configuration, the electronic moisture sensor 200 may be an integral or permanent feature of a tray 404. The electronic moisture sensor 200 in the illustrated embodiment is designed to slide directly onto trays 404 of the JEDEC style in common use such that no tray modifications are necessary. In yet another configuration the electronic moisture sensor is attached to the moisture sensitive product with an adhesive material.

Referring again to FIG. 1, once an association between the moisture sensitive product and the electronic moisture sensor is created 102, the electronic moisture sensor begins 104 sensing and recording data that is representative of moisture conditions inside the container. According to one implementation, sensing and recording data is performed continuously once started. Alternatively, sensing and recording may occur periodically. For example, sample points may be collected once every few seconds. Sensing and recording may involve measuring one or more data parameters that indicate a moisture content level inside the container. Such parameters can include, for example, temperature and relative humidity. Data indicating the sensed moisture exposure may be recorded as it is collected. Techniques for sensing and recording data related to moisture conditions are disclosed in U.S. Pat. No. 6,759,862 (Kou), entitled Method and Apparatus for Evaluating a Set of Electronic Components, which is hereby incorporated by reference. Other techniques for sensing and recording data related to moisture conditions are possible.

According to the illustrated method, the electronic moisture sensor continues sensing and recording 106 data until the occurrence of a triggering event that prompts the electronic moisture sensor to transmit data relevant to an assessment of the moisture sensitive product's condition to an external device. Examples of triggering events include the presence of a magnetic field, an incident light source, a particular motion and/or a temperature. The triggering event may be user-initiated or machine-initiated.

In some implementations, the triggering event is detected by a passive detection element in the electronic moisture sensor. The passive detection element can be, for example, a magnetic field detector, a motion detector (e.g. an accelerometer), a light detector or a temperature sensor. Preferably, the passive detection element uses very little (or no) energy, particularly when it is waiting to detect a triggering event. In response to detecting a triggering event, the passive detection element is adapted to prompt the transmission of data to an external device. In one implementation, the passive detection element is a magnetically responsive hall effect sensor.

If a triggering event is detected (at box 108) by the electronic moisture sensor, the electronic moisture sensor begins 110 transmitting data. In some implementations, the transmitted data represents a cumulative effect of exposure to ambient moisture (represented by the sensed and recorded data) on the associated moisture sensitive product. In one implementation, the transmission of data is conducted utilizing a radio frequency (RF) signal that can be transmitted through the container. Such transmission is possible even if the container is opaque, not transparent and/or not translucent. In other implementations, the transmission of data is accomplished using infrared (IR) transmission technology. If IR technology is used, then the container should be sufficiently transparent or translucent to allow the IR signal to pass through the container.

In one implementation, in response to the triggering event, the electronic moisture sensor 200 calculates and transmits a remaining floor life value associated with the moisture sensitive product to an external device. The remaining floor life value may simply be the last value of remaining floor life that was calculated by the electronic moisture sensor prior to transferring. Alternatively, the transfer-prompting by the operator might also prompt the electronic moisture sensor 200 to perform a final calculation of remaining floor life. In that instance, the result of the final calculation may be transferred in response to the triggering event.

The electronic moisture sensor also may transfer, in response to the triggering event, identification information relating to the associated moisture sensitive product.

Such identification information might include, for example, component part numbers, lot numbers, physical dimensions, and moisture characteristics. Such information may be received by and stored in an external device for further processing.

The transmitted data can be received by an external device. The external device may store and/or further process the received data. Typically, the electronic moisture sensor continues to transmit 112 data until the electronic moisture sensor determines (at box 114) that the transmission of data is complete. At that time, the transmission ends 116. In certain implementations, when the transmission ends, the transmitter enters a sleep-mode, where it uses a negligible (or no) amount of energy. After transmission ends, the electronic moisture sensor resumes (at box 106) sensing and recording data. In some implementations, the electronic moisture sensor continues to sense and record moisture data, even during a data transmission. However, when the transmitter is not transmitting it is generally in a low power consumption mode.

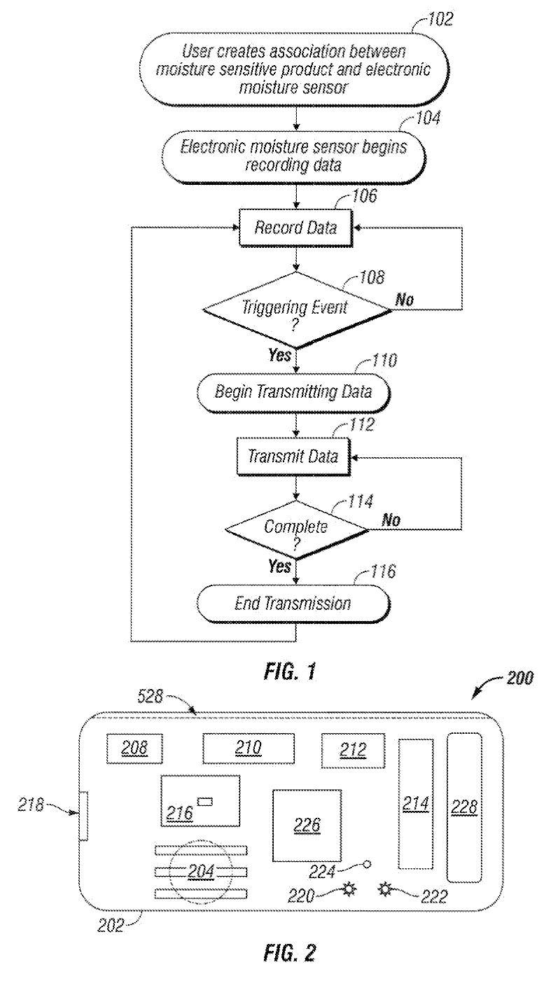

Referring to FIG. 2, an electronic moisture sensor 200 includes a housing 202 with several components mounted thereto. A moisture sensing element 204 is positioned proximate a plurality of openings 206 in the housing 202 that act as vents. Ambient air is allowed to pass through the vents to the moisture-sensing element 204. The moisture sensor also includes a memory storage unit 208, which may be an Electrically Erasable Programmable Read Only Memory (EEPROM) device. The memory storage unit may be adapted to store, for example, data representing sensed moisture, a calculated remaining floor life value, part and lot numbers associated with moisture sensitive products, moisture sensitivity information, etc. The electronic moisture sensor 200 also includes a processor 210 for processing various data. The electronic moisture sensor 200 also includes an RS 232 serial port 218 for inputting data to the memory storage unit 208 and for enabling access to data stored in the memory storage unit 208.

In the depicted implementation, a transceiver module includes a radio frequency (RF) module 212 and an antenna 214 and is adapted to communicate data to and from remote devices (e.g., computers, control systems or other moisture sensors) over a wireless communications channel. A passive, magnetically responsive element (e.g., a hall effect sensor) 216 is adapted to detect a triggering event and, in response, to actuate transmission of data by the transceiver module. In one implementation, the passive element 516 consumes a very small amount of energy while it is monitoring for the presence of a magnetic field. The RF module 212 may be, for example Linx model TXM-418-LC. The antenna 214 may be, for example, Linx model 418-SP1, single grounded line plane antenna. The remote device may be fitted with a corresponding antenna and RF module. For example, the remote device may be fitted with RF module Linx model RX M-418-LC-5.

The illustrated implementation includes colored light emitting diodes 220, 222. In particular, the illustrated embodiment includes a green light emitting diode (LED) 220 and a red LED 222 which can be accessible for viewing by an operator through a sufficiently transparent or translucent container. The illustrated implementation also includes a button 224 that can be accessible through a sufficiently pliable container. According to one embodiment, if the operator momentarily depresses the button 224, either the green LED 220 or the red LED 222 will illuminate. An illuminated green LED would indicate that the associated moisture sensitive product has not been excessively compromised by moisture exposure. In contrast, an illuminated red LED would indicate that the associated moisture sensitive product probably has been exposed to excessive moisture. Additionally, the electronic moisture sensor 200 could be adapted so that depressing the button 224 for an extended period of time resets the moisture sensor and clears some of the moisture exposure data from the memory storage unit 208. In another implementation, the LEDs 220, 222 can be activated by an triggering event applied by a user from outside the container. Such triggering event might involve application of a magnetic field, a light source, a particular temperature, a particular motion, etc.

A battery 226 provides power for each of the components of the electronic moisture sensor to operate. A dashed-line indicates a track 528 formed in the housing 202 for mating with an edge feature of an electrical component tray. An opening 228 is formed in the housing 202. The opening forms a handle, which a user might grip while causing the electronic moisture sensor to engage or disengage a corresponding moisture sensitive product.

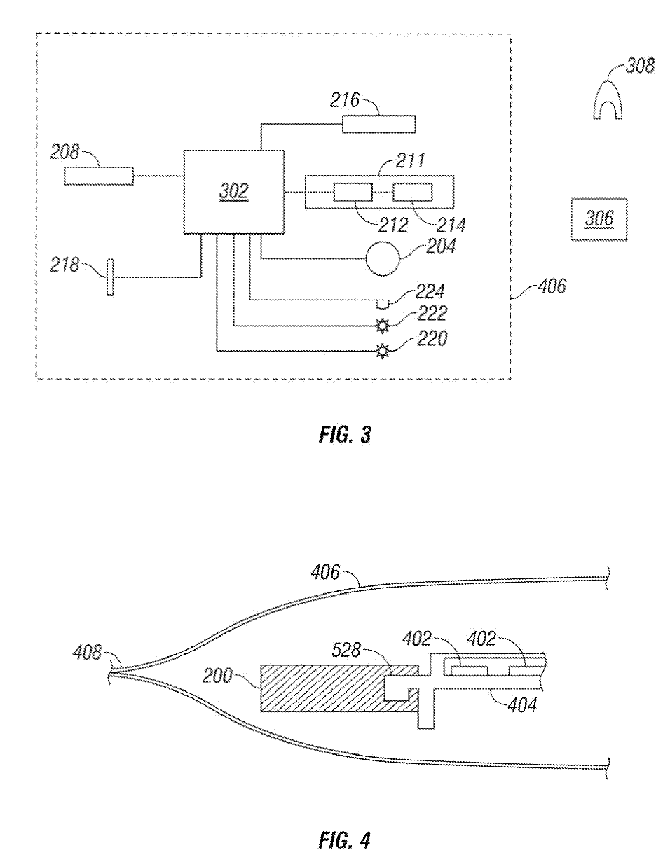

FIG. 3 is a block diagram of one implementation of a system for monitoring moisture in a container. The moisture sensor may also be referred to as a “sensor module” or a “moisture recorder” in various implementations.

According to the illustrated implementation, electronic moisture sensor 200 is positioned within a container 406 that acts as a moisture resistant barrier. Moisture sensing element 204 is coupled to processor 302. The moisture sensing element 204 is adapted to sense exposure to ambient moisture content and output signals that correspond to that sensed ambient moisture content. The signals can be output on a substantially continuous or periodic basis. The processor 302 is adapted to receive the output signals from the moisture-sensing element 204 and store data indicative of the sensed ambient moisture content in the memory storage unit 208, which also is coupled to the processor 302.

In one implementation, a set of data eventually is accumulated in the memory storage unit 208. The set of data represents ambient moisture exposure of an associated moisture sensitive product over time. The processor 302 is adapted to quantify a cumulative effect that the ambient moisture exposure over time has on an associated moisture sensitive product. In one implementation, that quantification takes into consideration moisture sensitivity characteristics of the associated moisture sensitive product. Such moisture sensitivity characteristics may be stored, for example, in the memory storage unit 208.

According to some implementations, quantifying the cumulative effect of moisture exposure involves calculating a reduction in remaining floor life for an associated electrical component over time based on the sensed moisture exposure. To perform such calculations, the electronic moisture sensor can use an initial value for remaining floor life value as a starting point in performing those calculations. That initial value might be, for example, 100%. Alternatively, other values of remaining floor life may be used as a starting point for remaining floor life calculations. In some instances it is desirable to establish an initial value for remaining floor life as close as possible to the creation of the association between the moisture sensitive product and the electronic moisture sensor. The electronic moisture sensor 200 can periodically calculate an updated remaining floor life value. This periodic updating can be performed at an approximately continuous rate. Alternatively, the remaining floor life value can be updated, for example, every few seconds. In order to update the remaining floor life value, the electronic moisture sensor can calculate a reduction in remaining floor life that the electrical components in the associated group experienced during a particular time period (e.g., a few seconds). Once a reduction in remaining floor life associated with a particular period of time is calculated, the electronic moisture sensor can decrement the previous remaining floor life value accordingly. To perform reduction in remaining floor life calculations, the electronic moisture sensor may implement standard techniques, such as those described in Joint Industry Standard, IPC/JEDEC J-STD-033A, Handling, Packing, Shipping and Use of moisture/Reflow Sensitive Surface Mount Devices.

The remaining floor life calculations can take into consideration particular physical characteristics of the moisture sensitive product. Accordingly, such physical characteristics should be available for reference to the electronic moisture sensor 200. In one implementation, an operator enters data about those physical characteristics into the electronic moisture sensor 200 either manually or otherwise. In another implementation, the electronic moisture sensor 200 is preprogrammed with such data corresponding to a particular type of moisture sensitive product.

Typical moisture sensitivity characteristics that are relevant to determining the effect of moisture exposure on electronic components, for example, include package type, body thickness and moisture sensitivity levels per JEDEC standards. Other parameters might be relevant as well.

In one implementation, quantifying the cumulative effect of moisture exposure includes calculating a remaining floor life of the associated moisture-sensitive products, based on the stored moisture exposure data. Such calculations might be performed in response to a triggering event (e.g., exposure to an external magnetic field) or on a periodic or substantially continuous basis. The results of those calculations might be stored in the memory storage unit 208.

In certain implementations, the processor 302 is adapted to determine the suitability of the moisture sensitive product for processing. For example, if the moisture sensitive product is an electronic component, the suitability determination might include determining whether the electronic components are suitable for exposure to reflow soldering conditions. The suitability determination may include, for example, comparing the latest remaining floor life value associated with the electronic component to a predetermined value, which may be an acceptability limit. If the total remaining floor life is greater than the predetermined value, the electrical component may be deemed suitable for exposure to reflow soldering conditions. The predetermined value of remaining floor life may be, for example, 100%, 50%, 30% or 0% of original floor life.

In one embodiment, the suitability determination is accomplished by a remote computer coupled for communication to the electronic moisture sensor 200. In another embodiment, the suitability determination is performed by the electronic moisture sensor 200 itself. If it is determined that a particular electrical component is suitable for exposure to reflow soldering conditions, then an electrical component placement machine (not shown) might be permitted to couple the electrical component to a destination circuit board for subsequent exposure to reflow soldering conditions. If, however, it is determined that an electrical component is not suitable for exposure to reflow soldering conditions, then the electrical component placement machine may alert the operator. Depending on the particular implementation, this may include triggering an audio and/or visual alarm, shutting down the component placement machine, or halting picking operations from the affected container of electrical components. One of skill in the art might recognize other ways in which an electrical component placement machine might react to an unfavorable suitability determination.

A passive, magnetically-responsive element 216 also is coupled to the processor 302. Element 216 is adapted to sense and respond to an externally-applied magnetic field. Typically, the response to application of such a magnetic field is the transmission of an activation-signal to the processor. A magnet 308 is positioned proximate to an outer surface of the container 406. The magnet 308 can provide the magnetic field. The electronic moisture sensor 200 may be adapted to respond to other types of externally-applied triggers, such as motion, temperature, infrared signals, radio frequency signals or other signals.

In one implementation, when the processor 302 receives the activation-signal, the processor 302 begins to quantify the cumulative effect of moisture exposure. Once the quantification is complete, the processor 302 activates the transceiver module 211 to begin transmitting various data from the memory storage unit 208. That transmission might include data related to the quantified cumulative effect. In another implementation, when the processor 302 receives the activation-signal, the processor 302 simply activates the transceiver module 211 to begin transmitting various data, relevant to moisture exposure, from the memory storage unit 208. In some implementations, the transceiver module 211 can be adapted to transmit data directly from the moisture sensing element 204.

In one implementation, the transceiver module 211 includes a radio frequency (RF) module 212 and an antenna 214. Other implementations can include a infrared (IR) transmission devices. In general, the transmission/transceiver module 211 is adapted to transmit data to an external device 306 that includes a receiver. The external device 306 may be, for example, a second moisture sensor or a controller for a circuit board assembly machine.

Green light emitting diode (LED) 220, red LED 222 and button 224 are electrically coupled to the processor 302. RS 232 connection 218 also is electrically coupled to the processor 302, which is adapted to store information from the RS 232 connection 218 to memory storage unit 208 and/or to output information from the memory storage unit 208 to an external component, such as a computer, though the RS 232 connection 218.

A number of implementations of the invention have been described. Nevertheless, it will be understood that various modifications may be made without departing from the spirit and scope of the invention. For example, other types of triggering events can be implemented. The transceiver module can be adapted to transmit and/or receive other types of data. The processor can be adapted to process and handle data in a variety of ways. A variety of container types can be used. Also, the techniques, can be used, to monitor inside a container holding any moisture sensitive product. Moreover, although the techniques disclosed herein relate to monitoring moisture inside a container, they could be adapted to monitoring other parameters, such as temperature, motion, light exposure, etc. Additionally, particular moisture sensors may be adapted for use with specific types of moisture sensitive products.

Accordingly, other implementations are within the scope of the following claims.

What is claimed is:

1. A method of monitoring moisture inside a container adapted to store a moisture sensitive product, the method comprising:
placing an electronic moisture sensor inside the container;
using the electronic moisture sensor to sense moisture conditions inside the container; and
in response to a triggering event initiated from outside the container, transmitting data through the container,
wherein the transmitted data is relevant to an assessment of the moisture sensitive product's condition, based on the recorded data.

2. The method of claim 1 further comprising detecting the triggering event with a passive sensing element.

3. The method of claim 2 further comprising:
applying a magnetic field as the triggering event; and
detecting the applied magnetic field with a hall effect sensor.

4. The method of claim 3 further comprising:
creating an activation signal from the hall effect sensor's reaction to the applied magnetic field; and
applying the activation signal to a transceiver in the electronic moisture sensor to begin the transmission.

5. The method of claim 3 wherein applying the magnetic field comprises positioning a magnet proximate to an outer surface of the container.

6. The method of claim 1 wherein the container provides a moisture resistant barrier around the moisture sensitive product and the electronic moisture sensor.

7. The method of claim 1 wherein the container is substantially opaque.

8. The method of claim 7 wherein transmitting the data comprises transmitting a radio frequency signal.

9. The method of claim 1 wherein the container is substantially transparent or substantially translucent, wherein transmitting the data further comprises transmitting an infrared signal.

10. The method of claim 1 further comprising recording data representing the sensed moisture conditions.

11. The method of claim 10 further comprising quantifying a cumulative effect of the moisture conditions over time based on the recorded data.

12. The method of claim 1 further comprising sealing the container to form a moisture resistant barrier around the moisture sensitive product and the electronic moisture sensor.

13. The method of claim 1 wherein the moisture sensitive product is a product selected from the group consisting of an electronic component, a pharmaceutical product, machinery and food.

14. A system comprising:
a container adapted to provide a moisture barrier around a moisture sensitive product; and
an electronic moisture sensor inside the container, the electronic moisture sensor comprising:
a moisture sensor adapted to sense ambient moisture conditions;
a memory storage device coupled to the moisture sensor and adapted to store data from the moisture sensor;
an internal transceiver module coupled to the memory storage device and adapted to transmit the stored data over a wireless communications channel; and
a passive, magnetically responsive element coupled to the transmission module and adapted to, in response to an applied magnetic field, activate the transmission module to begin transmitting.

15. The system of claim 14 further comprising an external transceiver module outside the container, wherein the external transceiver module is adapted to receive data that is transmitted by the internal transceiver module.

16. The system of claim 15 wherein the internal transceiver module and the external transceiver module are adapted to utilize radio frequency transmission techniques.

17. The system of claim 15 wherein the transmission module and the receiver module are adapted to utilize infrared transmission techniques.

18. The system of claim 14 further comprising a magnetic element adapted so that, when positioned proximate to an outer surface of the container, a reaction by the magnetically responsive element is triggered.

19. The system of claim 14 wherein the magnetically responsive element is a hall effect sensor.

20. The system of claim 14 wherein the electronic moisture sensor is further adapted to record data in the memory storage device representing the sensed ambient moisture conditions.

21. The system of claim 20 wherein the electronic moisture sensor is adapted to quantify a cumulative effect of a moisture sensitive product's exposure to moisture content over time, based on the recorded data.

22. The system of claim 15 wherein the moisture sensitive product is selected from the group consisting of: an electronic component, a pharmaceutical product, machinery and food.

23. An electronic moisture recorder comprising:
a moisture sensor element adapted to sense ambient moisture conditions;
a memory storage device coupled to the moisture sensor and adapted to store data from the moisture sensor element;
a transceiver module coupled to the memory storage device and adapted to transmit the stored data over a wireless communications channel; and
a passive, magnetically responsive element coupled to the transmission module and adapted, in response to an applied magnetic field, to activate the transmission module to begin transmitting.

24. The electronic moisture recorder of claim 23 wherein the transceiver module is a radio frequency transmission module.

25. The electronic moisture recorder of claim 23 wherein the magnetically responsive element is a hall effect sensor.
